(19) United States
(12) Patent Application Publication
(10) Pub. No.: US 2015/0158487 A1
(43) Pub. Date: Jun. 11, 2015

(54) METHOD FOR CHASSIS CONTROL AND CHASSIS CONTROL SYSTEM

(71) Applicant: AUDI AG, Ingolstadt (DE)

(72) Inventor: KARL-HEINZ SIEDERSBERGER, Ingolstadt (DE)

(21) Appl. No.: 14/563,524

(22) Filed: Dec. 15, 2014

(30) Foreign Application Priority Data
Dec. 9, 2013 (DE) 102013020558.1

(51) Int. Cl. B60W 30/02; B60W 40/09; B60W 40/02

(52) U.S. Cl. CPC B60W 30/02; B60W 40/02; B60W 40/09

(57) ABSTRACT

To achieve a general improvement in the driving stability of a motor vehicle, it is proposed to control the driving stability of the motor vehicle based on a continuously determined environment model, wherein the environment model is used for predictive adaptation of existing vehicle dynamics control systems.

### CROSS-REFERENCES TO RELATED APPLICATIONS

This application claims the priority of German Patent Application, Serial No. 10 2013 020 558.1, filed Dec. 9, 2013, pursuant to 35 U.S.C. 119(a)-(d), the content of which is incorporated herein by reference in its entirety as if fully set forth herein.

### BACKGROUND OF THE INVENTION

The present invention relates a method for the chassis control of a motor vehicle and a corresponding chassis control system.

According to, the current state of the art, chassis control systems in motor vehicles, for example ESC, damper control, all-wheel control, etc., often support the driver also in critical road scenarios and hence contribute considerably to enhancing vehicle safety. These systems intervene in the driving operation under particular circumstances primarily to stabilize the vehicle. For this purpose, the above-mentioned exemplary systems use information from vehicle sensors that measure vehicle conditions, such as yaw rate, lateral acceleration and/or brake pressure.

Sensors used by chassis control systems are only able to measure a current condition at the respective current time, allowing the chassis control systems to only respond to the current vehicle condition. However, at the current time, chassis control systems have no perspective beyond the current time. In many cases, however, chassis control systems such as ESC could still provide better performance when the future driving action would be known. In the case of a quick lane change, the ESC could at the beginning of the lane change, if it were known in advance that this lane change was imminent, initiate an optimized control strategy for the lane change and thus develop an even better outcome.

It would therefore be desirable and advantageous to obviate prior art shortcomings and to generally improve the driving stability of a motor vehicle.

### SUMMARY OF THE INVENTION

According to one aspect of the present invention, the driving stability of a motor vehicle is controlled based on a continuously determined environment model which is used for a forward-looking or predictive adaptation of respective existing vehicle dynamics control systems. According to the invention, isolated individual scenarios, such as an evasive emergency maneuver or cornering, are thus no longer examined. According to the invention, mutually separated partial control systems are also no longer accessed. By better utilizing resources already present in the respective motor vehicle and with improved efficiency, an adaptation to a respective current and immediate future driving situation is controlled directly by using as a future path of the motor vehicle a trajectory based on a continuously updated environment model, which may also contain obstacles or curves, via a stabilization level.

Advantageously, the method is implemented based on a layered model that includes a route control level, a stabilization level as well as a hardware level. This approach can be used universally as a structured superstructure even with motor vehicles equipped with different vehicle dynamics control systems, because in particular the stabilization level and the hardware level can be freely adapted to the respective possibilities of the respective motor vehicle.

Based on the continuously updated environment model, a current drive situation and/or imminent future drive situations are determined as an imminent future path of the motor vehicle by using a trajectory. Preferably, information about a respective driver is used within this system and processed as additional environment information, wherein this information has been collected, for example, during previous journeys along the same route and learned in the course of an evaluation.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic block diagram of an exemplary embodiment of a device for the chassis control according to the present invention inside an unillustrated motor vehicle.

### DETAILED DESCRIPTION OF PREFERRED EMBODIMENTS

The depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

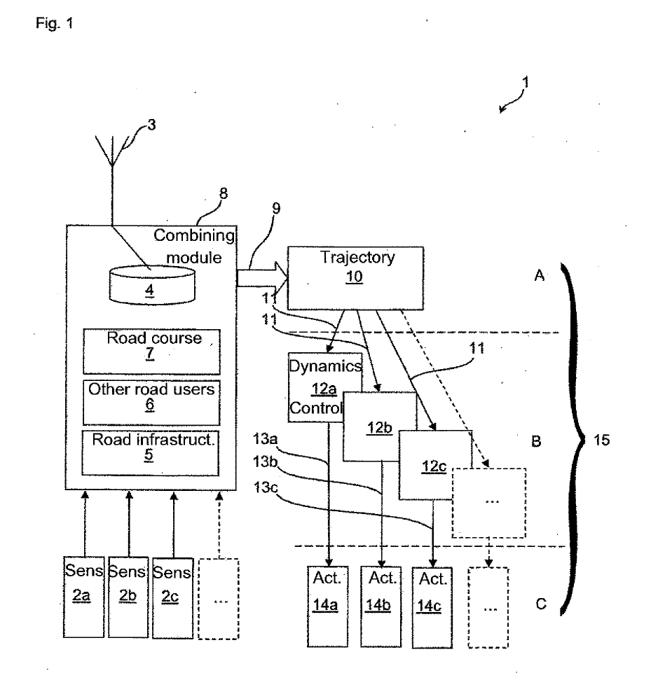

Turning now to the drawing, and in particular to FIG. 1, there is shown a device 1 which includes environment sensors 2a, 2b, 2c, . . . from the field of driver assistance devices, such as a camera, ultrasonic distance sensors, radar, laser scanners, etc. These environment sensors 2a, 2b, 2c, . . . continuously sample and survey a vehicle environment. A current position of the motor vehicle is determined in a map database 4 with an antenna 3. These data together with means 5 for detecting a road infrastructure, means 6 for detecting other road users and means 7 for determining a course of a road are used in a module 8 for continuously detecting the environment. By combining the aforementioned partial information, the module 8 transmits, for determining a trajectory 11, to a module 10 an updated environment model 9 that is continuously updated based on the aforementioned data sources.

An image of the environment, such as the course of the road or of other road users, etc. is generated by using these environment sensors 2a, 2b, 2c, . . . A trajectory 11 showing future movements of the vehicle can be determined based on the information about the environment. The trajectory 11 is continuously determined from the environment model 9. It is irrelevant whether a driver or a driver assistance device manages the vehicle. In addition to environmental information, information about a particular driver collected or learned in the course of an evaluation, in particular when driving the same route as during previous trips, is used for determining the trajectory 11. The generated trajectory 11 is handed over to the chassis control systems 12a, 12b, 12c, which can then customize and optimize their respective control strategies based on the trajectory 11.

The trajectory 11 thus describes an immediate future route of the motor vehicle. The trajectory 11 is passed as a target value to the stability control systems 12a, 12b, 12c, 14a, which then output and control on this basis actuating signals 13a, 13b, 13c, . . . to corresponding actuators, 14b, 14c, . . . of the chassis.

A three-layer model 15 is here implemented for a flexible adaptation to various motor vehicles having different equipment in form of driver assistance systems and corresponding environment sensors 2a, 2b, 2c, . . . and stability control systems 12a, 12b, 12c, . . . and associated actuators 14a, 14b, 14c, . . . In this model, the module 10 for determining a trajectory 11 is part of a so-called route control level A, the vehicle dynamics control systems 12a, 12b, 12c, . . . connected via the respective trajectory 11 are part of a stabilization level B, and the actuators 14a, 14b, 14c, are part of a hardware level C.

The continuously updated environment model 9 is used for predictive adaptation of the vehicle dynamics control systems. Unlike with conventional approaches, the control is not performed based on a singular trajectory that is passed on to only one of several chassis control systems existing in a motor vehicle. Based on the generalized environment model, each of the different chassis control systems continuously adapts to a respective current situation.

The device can be integrated with comparatively little additional effort into existing control systems in modern motor vehicles and updated in a conventional manner.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for chassis control of a motor vehicle, comprising:
controlling a driving stability of the motor vehicle based on a continuously determined environment model, and
using the environment model for predictive adaptation of vehicle dynamics control systems present in the motor vehicle.

2. The method of claim 1, wherein the method utilizes a layered model comprising a course control level, a stabilization level, and a hardware level.

3. The method of claim 2, wherein at least one of the stabilization level and the hardware level is freely adaptable to respective possibilities of a respective motor vehicle.

4. The method of claim 3, wherein the hardware level includes all vehicle dynamics control systems of the respective motor vehicle.

5. The method of claim 1, wherein based on the environment model, at least one of a current and an immediate future driving situation is determined as the immediate future route of the motor vehicle by using a trajectory.

6. The method of claim 1, further comprising using in the environment model information about a particular driver as additional environment information, wherein the additional environment information was collected during previous trips along an identical previously traveled route and evaluated.

7. A device for chassis control of a motor vehicle, comprising:
a course control level configured to determine at least one of a current and an immediate future driving situation,
a stabilization level receiving from the course control level a trajectory generated as an immediate future driving path of the motor vehicle, said stabilization level comprising controllers or vehicle dynamics control systems for chassis actuators, and
a hardware level comprising the chassis actuators.
